(19) United States
(12) Patent Application Publication
(10) Pub. No.: US 2007/0060224 A1
(43) Pub. Date: Mar. 15, 2007

(54) Mobile phone case

(76) Inventor: Ming-Chin Liu, Taipei County (TW)

Correspondence Address: HARNESS, DICKEY & PIERCE, P.L.C., P.O. BOX 8910, RESTON, VA, 20195, US

(21) Appl. No.: 11/225,034

(22) Filed: Sep. 14, 2005

(51) Int. Cl. H04M 1/00

(52) U.S. Cl. 455/575.8

(57) ABSTRACT

A mobile phone case has two shells and an elastic piece. The shells each have an inner concave. As the two shells are closed to each other, the two inner concaves face to each other to form a chamber. The elastic piece is bent and two ends of the elastic piece are clipped on one side of the two shells to generate an elastic force constantly to drive the two shells close to each other. A mobile phone may be held in the chamber. The two shells can be pried open by an external force applied to the side opposite where the elastic piece is located so that the chamber can be exposed, the mobile phone can be taken out from the chamber or placed into the chamber. When the external force is absent, the elastic piece drives the two shells close to each other again.

### BACKGROUND OF THE INVENTION

1. Field of Invention

The invention relates to a mobile phone case, and particularly to a mobile phone case that has a hard shell to withstand impact.

2. Related Art

The mobile phone has become the mainstream of telecommunication, replacing the traditional wired telephone.

For carrying a mobile phone, most people place the mobile phone in a mobile phone case and take the mobile phone out from the case when in use. The mobile phone case is used to protect the mobile phone from being scratched. Refer to FIGS. 1 and 2 for the generally used mobile phone cases. FIG. 1 shows one with a flexible case 1 made from flexible material such as fabric, plastics or the like. A mobile phone 2 can be held in the flexible case 1. The flexible case 1 has an opening 1a that may be contracted with an elastic band 3 to prevent the mobile phone 2 from slipping out. The elastic band 3 is coupled with the flexible case 1 through a Velcro tape so that the elastic band 3 can be unfastened or fastened quickly to open or close the opening 1a. Buckles or the like may also be adopted for coupling. FIG. 2 illustrated another type of mobile phone case. It has a flexible case 4 and an elastic band 5 in the middle portion of the flexible case 4. The middle portion can be contracted to hold a mobile phone 2 contained in the flexible case 4 and prevent it from slipping out. In addition, the mobile phone case may also be made from transparent material matching the profile of the mobile phone to form a snug covering. Then the mobile phone can be directly operated and the screen of the mobile phone can be seen through the mobile phone case without taking the mobile phone out from the mobile phone case.

Because the conventional mobile phone cases are made from flexible material, while they can protect the mobile phone from being scratched, they do not provide rigid protection and cannot withstand external impact. Since the mobile phone is a delicate electronic device, it cannot withstand impact, and is easily damaged if impact occurs. Moreover, the conventional design to hold the mobile phone in a case or seal the opening of the case with Velcro or buckles is easy to use, but it tends to wear off after frequent coupling and separating, and the coupling effect deteriorates. Adopting a more elaborate coupling mechanism with better coupling effect will increase the production cost of the mobile phone case. Using the elastic band or fabric to contract the pouch and mobile phone makes operation simpler. But the durability of the elastic band or fabric is generally short, and the elasticity of the elastic band or fabric decreases after a period of time. Hence the contracting function for holding the mobile phone is lost.

### SUMMARY OF THE INVENTION

In view of the aforesaid problems, the primary object of the invention is to provide a mobile phone case with a rigid protection, so that the mobile phone is not damaged by impact. It is simple and easy to use, and can hold the mobile phone securely to prevent the mobile phone from escaping the mobile case.

To achieve the foregoing object, the mobile phone case according to the invention includes two shells and an elastic piece. The shells have an inner concave and can be coupled together to form a chamber. The elastic piece is bent to clip one side of each shell. The elastic piece generates an elastic force constantly to drive the two shells close to each other. A mobile phone can be held in the chamber. When the two shells are separated by an external force, the chamber is exposed and the mobile phone can be taken out from the chamber or placed into the chamber. When the external force is absent, the elastic piece drives the two shells close to each other again.

The shells of the invention are rigid, so they can withstand impact better than the conventional flexible cases made from a flexible material. Hence the mobile phone can be protected. In addition, the two shells are driven close to each other by the elastic piece, so there is no wearing of elements during separation or closing of the shells. Durability of the invention is thus improved.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIGS. 1 and 2 are perspective views of conventional mobile phone protection cases;

FIG. 3 is an exploded view of a first embodiment of the invention;

FIG. 4 is a perspective view of the first embodiment of the invention;

FIG. 5 is a perspective view of a variation of the first embodiment of the invention;

FIG. 6 is a schematic view of the first embodiment in use;

FIGS. 7 and 8 are sectional views of the first embodiment of the invention;

FIG. 9 is a perspective view of a second embodiment of the invention; and

FIG. 10 is a perspective view of a third embodiment of the invention.

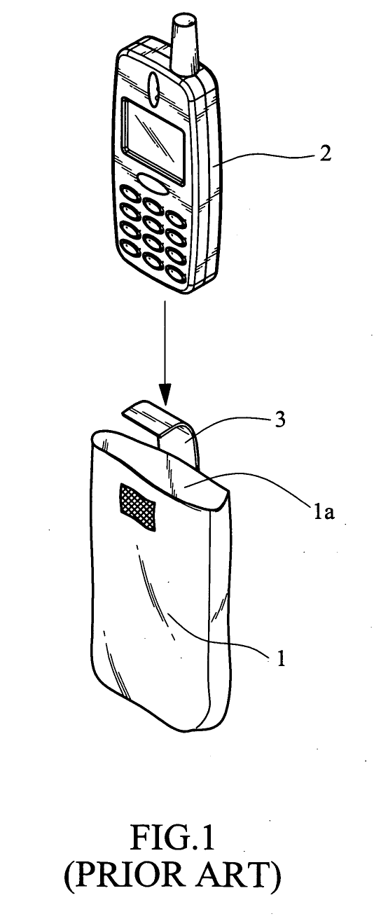

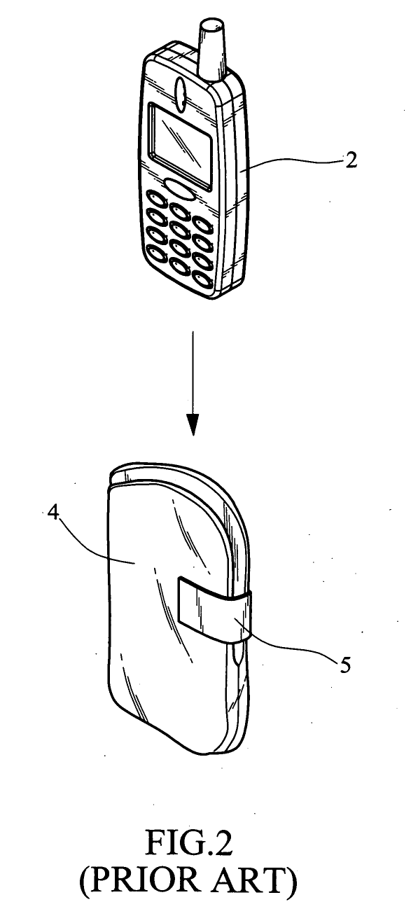

### DETAILED DESCRIPTION OF THE INVENTION

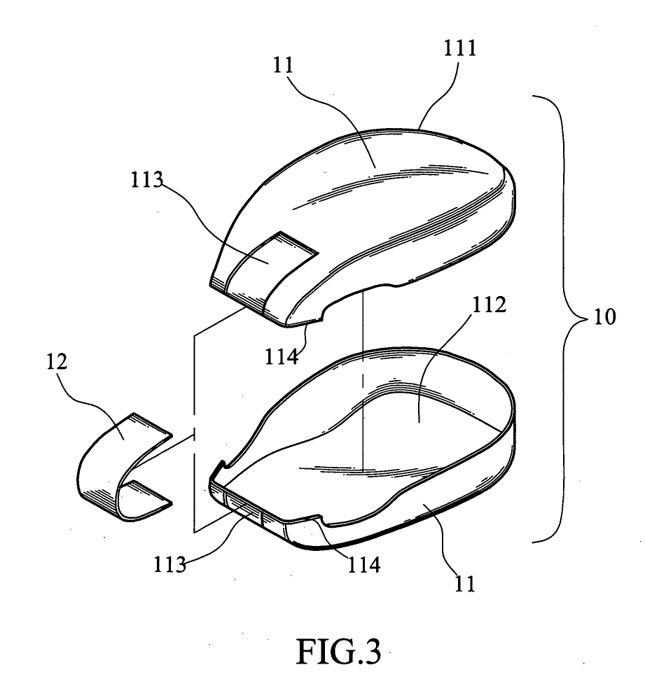

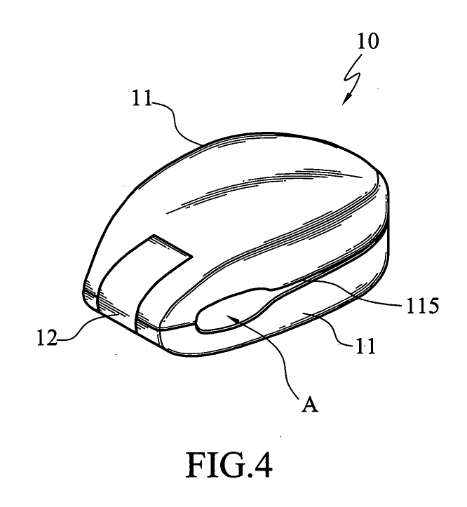

Refer to FIGS. 3 through 5 for a first embodiment of the invention. It is a mobile phone case 10 that includes two shells 11 and an elastic piece 12.

Each of the shells 11 has a convex surface 111 outside and an inner concave 112 inside. The two shells 11 mate with the inner concaves 112 facing each other. When the two shells 11 are close to each other, the two inner concaves 112 form a chamber A to hold an article.

The elastic piece 12 is bent. When the two shells 11 are closed with the edges of the inner concaves 112 facing with each other, two ends of the elastic piece 12 are clipped on one side of the shells 11 respectively to provide an elastic force constantly to keep the two shells 11 closed without separating. The article can be held in the chamber A without escaping. Each of the two shells 11 has a groove 113 to insert the elastic piece 12 therein. The two ends of the elastic piece 12 can be anchored in the grooves 113 to prevent the elastic piece 12 from sliding and separating from the two shells 11.

After the two shells 11 are closed, their edges are not necessary fully in contact with each other. Partial edges of the two shells 11 where the elastic piece 12 located can be defined as coupling edges 114. The coupling edges 114 are coupled with each other to form a tight connection. The rest of the edge of the two shells 11 has a narrow gap 115 therebetween after the two shells 11 are closed. Hence the article held in the shells 11 can be seen through the narrow gap 115. The narrow gap 115 also allows the two shells 11 to be separated easily with the user's finger insert therein against the elastic force generated by elastic piece 12 to take the article out or place the article into the chamber A.

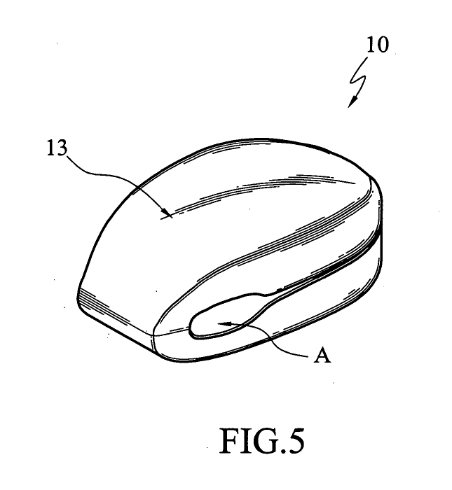

After the two shells 11 and the elastic piece 12 have been coupled, they may be covered by a pliable covering layer 13 made from leather, foamed rubber, foamed plastics or the like, as shown in FIG. 5. The covering layer 13 can provide cover protection to enable the elastic piece 12 to be securely anchored on the two shells 11. It can also increase the appeal of the device, provide a cushion effect, and prevent scratching and wearing of the shells 11.

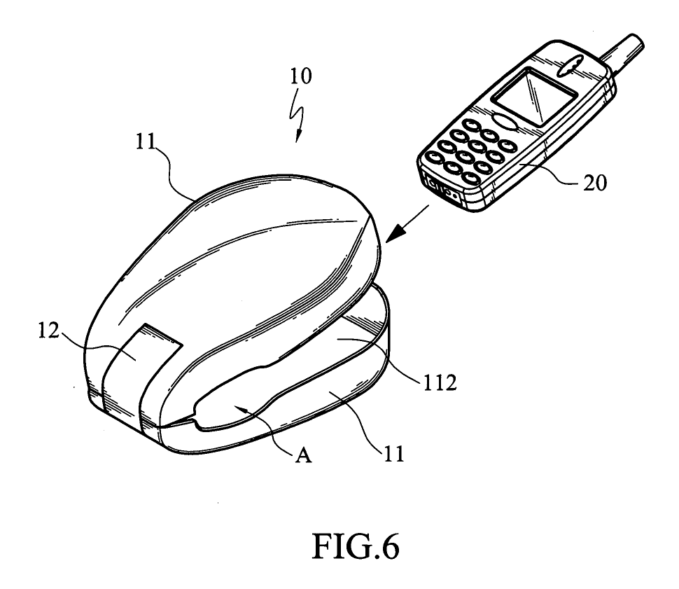

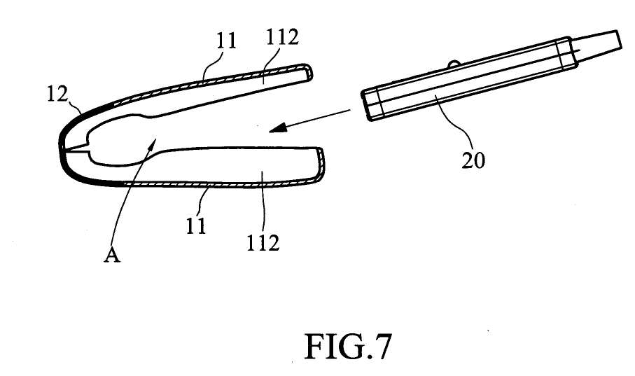

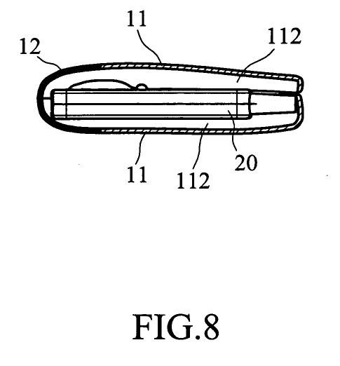

Refer to FIGS. 6, 7 and 8 for the first embodiment in use. The two shells 11 may be opened by a force applied to the side opposite to where the elastic piece 12 is located. The elastic piece 12 is deformed, generating an elastic force in the opposite direction. After the two shells 11 are separated and form an inclined angle therebetween, a mobile phone 20 may be placed in the chamber A. Then release one of the two shells 11. The elastic force of the elastic piece 12 drives the two shells 11 close to each other to hold the mobile phone 20 securely in the chamber A. The mobile phone 20 is exposed and can be taken out easily by separating the two shells 11. The shells 11 are made from hard plastics such as polyvinyl chloride (PVC) or the like. Their shape can remain intact under external impact. Thus the mobile phone 20 held inside can be protected from direct impact.

In another aspect, the inner concave 112 may be formed on only one of the shells 11, while the other shell 11 covers the opening of the inner concave 112 to form the chamber A. The inner concave 112 may further be formed to match the profile of the mobile phone 20 so that when the mobile phone 20 is held in the chamber A, it can be coupled securely with the shells 11 without shaking.

The invention may also adopt an integrated design to form the two shells and the elastic piece into one piece.

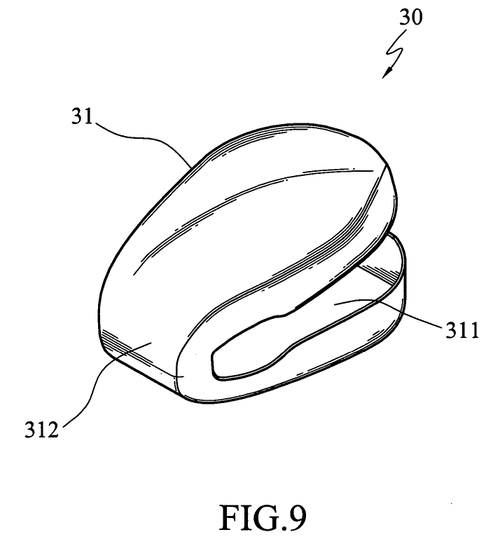

Refer to FIG. 9 for a second embodiment of a mobile phone case 30. It has a shell 31 with an inner concave 311 on one side and a bent section 312 in a middle portion so that the shell 31 can be folded with the side where the inner concave 311 is formed to form a chamber. The shell 31 is made from hard plastics such as PVC or the like. The bent section 312 has elastic and deforming capability to provide an elastic force to drive the shell 31 to be folded. The shell 31 remains folded to each other to protect a mobile phone held in the chamber as an external force is not applied. Applying a force to unfold the shell 31, the inner concave 311 is exposed, and the mobile phone can be taken out or placed in.

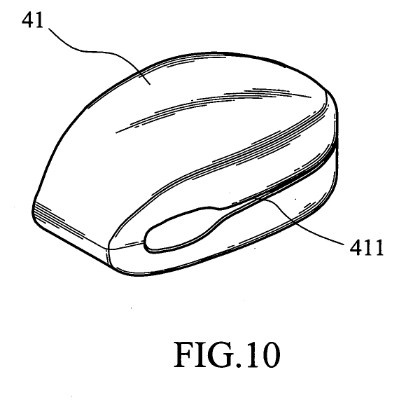

Refer to FIG. 10 for a third embodiment of the invention. A shell 41 is preformed with a hollow chamber inside. There is a slit 411 formed on one side of the shell 41. Thus two sides of the shell adjacent to the slit 411 can be opened by force to expose the chamber.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A mobile phone case, comprising:
two shells close to each other to form a chamber; and
an elastic piece located on one side of the two shells to generate an elastic return force to drive the two shells close to each other.

2. The mobile phone case of claim 1, wherein each of the shells has a convex surface and an inner concave, the inner concaves of the two shells facing each other and being coupled to form the chamber.

3. The mobile phone case of claim 1, wherein one of the shells has an inner concave facing another shell to form the chamber.

4. The mobile phone case of claim 1, wherein the elastic piece is bent and two ends of the elastic piece are clipped on one side of the shells respectively.

5. The mobile phone case of claim 4, wherein the two shells have respectively a groove to insert the ends of the elastic piece therein.

6. The mobile phone case of claim 4, wherein each of partial edges where the elastic piece located of the two shells are coupled with each other to form a tight connection, and the rest of the edge of the two shells has a narrow gap therebetween.

7. The mobile phone case of claim 1, wherein the shells are made from hard plastics.

8. The mobile phone case of claim 7, wherein the shells are made from polyvinyl chloride (PVC).

9. The mobile phone case of claim 1, wherein the shells and the elastic piece are covered by a covering layer.

10. A mobile phone case, comprising:
a shell which has a middle portion bent to form a bent section such that the shell is folded to form a chamber.

11. The mobile phone case of claim 10, wherein the shell has an inner concave on one side to form the chamber.

12. The mobile phone case of claim 10, wherein the shell is made from hard plastics which are elastic.

13. The mobile phone case of claim 12, wherein the shell is made from polyvinyl chloride (PVC).

14. A mobile phone case, comprising:
a shell which has a hollow chamber and a slit on one side to allow the shell to be pried open on two sides adjacent to the slit.
